(19) United States
(12) Patent Application Publication
(10) Pub. No.: US 2024/0242107 A1
(43) Pub. Date: Jul. 18, 2024

(54) Machine Learning for Predicting Incremental Changes in Session Data

(71) Applicant: Google LLC, Mountain View, CA (US)

(72) Inventors: Ming Sun, New York, NY (US); Teresa Chaisiri, New York, NY (US)

(21) Appl. No.: 18/009,439

(22) PCT Filed: Jun. 24, 2022
(86) PCT No.: PCT/US2022/034936

§ 371 Date: Dec. 9, 2022

(51) Int. Cl. G06N 20/00

(52) U.S. Cl. CPC G06N 20/00

(57) ABSTRACT

A computing system and method that can be used for facilitating data processing and system modeling of techniques used to transmit network resources over a communication network. In particular, a machine learning system can execute predictive models for predicting probabilities of user session data based on feature data. For example, the computing system can predict that a user may have a low likelihood of engaging in a particular action (e.g., downloading specified content, completing a transaction, interacting with a specific icon, widget, or application, launching a specific script, or some other specified action) prior to engaging with the network resource but have a high likelihood of engaging in the particular action post engaging with the network resource. In particular, the computing system can provide for generating an incremental label which indicates a probability of how likely a particular user is to change from not engaging in a particular action to engaging in a particular action after engaging with the network resource.

### FIELD

The present disclosure relates generally to machine learning models. In particular, the present disclosure is directed to systems and methods for using machine learning models to predict incremental changes in session data resultant from providing a network resource.

### BACKGROUND

The Internet facilitates the exchange of information between users across the globe. This exchange of information enables distribution of content to a variety of users. In some situations, content from multiple different providers can be integrated into a single electronic document to create a composite document. For example, a portion of the content included in the electronic document may be selected (or specified) by a publisher of the electronic document. A different portion of content (e.g., network resource) can be provided by a third-party (e.g., an entity that is not a publisher of the electronic document and/or does not have access to modify code defining the electronic document).

In some situations, the network resource is selected for integration with the electronic document after presentation of the electronic document has already been requested and/or while the electronic document is being rendered. For example, machine executable instructions included in the electronic document can be executed by a client device when the electronic document is rendered at the client device. The executable instructions can enable the client device to contact one or more remote servers to obtain a network resource that will be integrated into the electronic document while presented at the client device.

### SUMMARY

Aspects and advantages of embodiments of the present disclosure will be set forth in part in the following description, or can be learned from the description, or can be learned through practice of the embodiments.

One example aspect of the present disclosure is directed to a computing system comprising one or more processors configured to perform a method. The method comprises providing a network resource to a first plurality of users. The method comprises obtaining a first set of index data associated with the first plurality of users, the first set of index data describing first user session data for the first plurality of users subsequent to receipt of the network resource. The method comprises obtaining a second set of index data associated with a second plurality of users, the second set of index data describing second user session data for the second plurality of users in the absence of the network resource. The method comprises training one or more machine learning models based on the first set of index data and the second set of index data. The method comprises generating by the computing system using the one or more machine learning models, a first probability and a second probability for each of a third plurality of users based on feature data associated with such user, wherein the first probability is a respective probability of user session data subsequent to receipt of the network resource and the second probability is a respective probability of the user session data in absence of the network resource. The method comprises generating an incremental label for each of the third plurality of users, wherein the respective incremental label for each of the third plurality of users is descriptive of a difference in the first probability and the second probability for such user.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

A full and enabling description of the present disclosure, directed to one of ordinary skill in the art, is set forth in the specification, which makes reference to the appended figures, in which:

FIG. 1A depicts a block diagram of an example computing system that performs transmittal of network resources over a communication network according to example embodiments of the present disclosure.

FIG. 1B depicts a block diagram of an example computing device that performs transmittal of network resources over a communication network according to example embodiments of the present disclosure.

FIG. 1C depicts a block diagram of an example computing device that performs transmittal of network resources over a communication network according to example embodiments of the present disclosure.

FIG. 2 depicts a block diagram of an example network resource effectiveness prediction model according to example embodiments of the present disclosure.

FIG. 3 depicts a block diagram of a further example network resource effectiveness prediction model according to example embodiments of the present disclosure.

FIG. 4 depicts a block diagram of a further example network resource effectiveness prediction model according to example embodiments of the present disclosure.

FIG. 5 depicts a block diagram of a further example network resource effectiveness prediction model according to example embodiments of the present disclosure.

FIG. 6 depicts a block diagram of a further example network resource effectiveness prediction model according to example embodiments of the present disclosure.

FIG. 7 depicts an example graphical representation of the performance of a causal model: and

FIG. 8 depicts a flow chart of an example method for predicting probabilities of user session data based on feature data.

### DETAILED DESCRIPTION

### Overview

Generally, the present disclosure is directed to systems and methods for facilitating data processing and system modeling of techniques used to transmit network resources over a communication network. In particular, a machine learning system can execute predictive models for predicting probabilities of user session data based on feature data. For example, the computing system can predict that session data may have a particular outcome or exhibit a particular characteristic with a first probability when a network resource is provided. In contrast, the computing system can predict that session data may have the particular outcome or exhibit the particular characteristic with a second probability in the absence of the network resource being provided. The computing system can generate an incremental label descriptive of a difference in the first probability and the second probability. Thus, in some examples, the incremental label can be descriptive of a predicted change in session data affected by providing the network resource. Depending on the objective, the computing system can use the incremental label to determine whether or not to provide the network resource.

One example application of the techniques described herein is for determining how providing a network resource may affect user interactions with the computing system (e.g., as captured in or reflected by session data). For example, a user may have a low likelihood of engaging in a particular action (e.g., downloading specified content, completing a transaction, interacting with a specific icon, widget, or application, launching a specific script, or some other specified action) prior to engaging with the network resource but have a high likelihood of engaging in the particular action post engaging with the network resource. The computing system can reference one or more indexes of data relating to various groups of users (e.g., a group of users which have engaged with the network resource and a group of users which have not engaged with the network resource) upon which the machine learning model can be trained.

Traditionally, users have a wide variety of responses to engaging with network resources such as becoming more likely to engage in a particular action, less likely to engage in a particular action, or not changing the likelihood of engaging in a particular action at all. However, historically network resources have been provided to users without taking into account users' responses to engaging with the network resource. In some cases, this creates a negative user experience. Furthermore, providing network resources indiscriminately to a user's reaction wastes computing system resources such as bandwidth and display space, creating an even further negative user experience. Additionally, providing network resources indiscriminately to a user's reaction wastes the money spent to provide network resources to users.

Advantageously, example embodiments according to aspects of the present disclosure can provide for a streamlined method to predict which users to surface network resources to. Additionally, or alternatively, example embodiments can provide for a method of training a machine learning model to generate predictions as to which users to surface network resources to. For example, surfacing may otherwise be referred to as displaying or otherwise providing the network resources. As a particular example, the network resources can be surfaced to only users with an improved probability of particular session data.

In some embodiments, the computing system can provide for generating an incremental label which indicates a probability of how likely a particular user is to change from not engaging in a particular action to engaging in a particular action after engaging with the network resource. For example, the computing system can provide the network resource to a first plurality of users as well as not provide the network resource to a second plurality of users. For instance, as a highly simplified example, the computing system can obtain indices of data indicating that “user A associated with feature 2 engaged in the particular action subsequent to receipt of the network resource.” In response, the computing system can train one or more machine learning models based on the data obtained from the first and second plurality of users in order to generate predicted incremental labels for each of a respective third plurality of users.

According to an aspect of the present disclosure, in some implementations, a computing system comprising one or more processors and one or more non-transitory, computer-readable media that store instructions that when executed by the one or more processors cause the computing system to perform operations. In particular, the computing system may provide a network resource to a first plurality of users. Furthermore, the computing system can obtain a first set of index data. In particular, the first set of index data can be associated with the first plurality of users. Even more particularly, the first set of index data can describe feature data for each of the first plurality of users and a set of first user session data for the first plurality of users. Specifically, the user session data can be subsequent to the receipt of the network resource. As a particular example, some number of users may engage in a particular action such as downloading specified content after receipt of the network resource. Alternatively, some number of users may not engage in the particular action such as downloading specified content after receipt of the network resource. Continuing the example, the first set of index data can indicate users who did or did not download the specified content after receiving the network resource.

In some implementations, the computing system can obtain a second set of index data. In particular, the second set of index data can be associated with a second plurality of users (e.g., separate from the first plurality of users). Even more particularly, the second set of index data can describe feature data for each of the second plurality of users and second user session data for the second plurality of users. The feature data for the second plurality of users can be from a shared feature space relative to the feature data for the first plurality of users. Specifically, the second user session data can be descriptive of user session data of the second plurality of users in the absence of the network resource. As a particular example, some number of users may engage in a particular action such as downloading specified content in the absence of any network resource. Alternatively, some number of users may not engage in the particular action such as downloading specified content without any network resource. Continuing the example from above, the second set of index data can indicate users who did or did not download the specified content without receiving any network resource.

In some implementations, the computing system can train one or more machine learning models. In particular, the computing system can train one or more machine learning models based on the first set of index data. Furthermore, the computing system can train the one or more machine learning models based on the second set of index data. Continuing the example from above, the computing system can train the one or more machine learning models by inputting index data describing whether individual users downloaded the specified content with and without receiving a particular network resource.

In some implementations, the computing system can generate a first probability. In particular, the first probability can be directed to a respective probability of user session data for each of a third plurality of users based on feature data associated with each of the third plurality of users. For example, the respective probability of user session data can be directed to probability data descriptive of the probability of the output of particular user session data subsequent to receipt of the network resource. Continuing the particular example from above, the first probability can be directed to the probability that a particular user will download the specified content subsequent to receipt of the network resource. Furthermore, the computing system can generate a second probability. In particular, the second probability can be directed to a second respective probability of user session data for each of the third plurality of users. For example, the second respective probability of user session data can be directed to predicting probability data descriptive of the probability of the output of particular user session data in the absence of the network resource. Continuing the particular example from above, the second probability can be directed to the probability that a particular user will download the specified content in the absence of the network resource.

In some implementations, the computing system can generate a respective incremental label. In particular, the computing system can generate the respective incremental label using the one or more machine learning models. Even more particularly, the computing system can generate the respective incremental label for each of a third plurality of users (e.g., separate from the first and second plurality of users). Specifically, the computing system can generate the respective incremental label for each of the third plurality of users based on feature data associated with each user. For example, feature data can be any user demographic information (e.g., age, geographic location, occupation, etc.). As another example, feature data can be historical user data (e.g., user browsing history, user location history, etc.). In particular, users may have the option to indicate whether they approve of sharing demographic information and/or historical user data with the computing system (e.g., by indicating on a user interface whether they approve or not). Even more particularly, the incremental label for each of the third plurality of users can be descriptive of a difference in the first probability and the second probability.

In some implementations, feature data descriptive of demographic or historical user data can be associated with each of the plurality of users in the first and second plurality of users. Thus, users in the third plurality of users can be associated with particular users in the first and second plurality of users with feature data that is within a threshold of similarity.

In some implementations, the respective incremental label for each of the third plurality of users can be descriptive of a change in the probability of particular user session data output by providing the network resource to the user. Continuing the above example, the respective incremental label may indicate the change in likelihood of a particular user downloading the specified content after receiving the network resource relative to not receiving the network resource. Thus, the incremental label can represent a counterfactual prediction that describes the causal effect that providing the network resource will have on the likelihood of a particular user downloading the specified content.

In some implementations, the computing system can rank the third plurality of users. In particular, the computing system can rank the third plurality of users based at least in part on the incremental label (e.g., generated by the one or more machine learning models). Continuing the example from above, the computing system can rank individual users based on their respective incremental labels representative of the difference in predicted outcome with and without receiving the network resource. As a particular example, the individual users can be ranked such that the users with the largest associated incremental labels are ranked higher than users with smaller associated incremental labels.

In some implementations, the computing system can provide the network resource to each of the third plurality of users. In particular, the computing system can provide the network resource to each of the third plurality of users based on the ranking. Furthermore, the computing system can determine whether to provide the network resource to each of the third plurality of users. Specifically, the computing system can determine whether to provide the network resource to each of the third plurality of users based at least in part on the ranking. Even more specifically, the computing system can provide the network resource to each of the third plurality of users for which a determination was made to provide the network resource. Continuing the example from above, the computing system can provide the network resource to only the users who are predicted to react favorably, (e.g., download the specified content) after receiving the network resource. As a particular example, the computing system may only provide the network resource to particular users who are ranked above a predetermined threshold in the ranking of the third plurality of users. Alternatively, the network resource may only provide the network resource to particular users with a combined score of rank and incremental label above a predetermined threshold value.

In some implementations, the computing system can train a first machine learning model on the first set of index data. In particular, the first machine learning model can be configured to output a first prediction. Even more particularly, the first prediction can describe the probability of particular user session data output subsequent to receipt of the network resource. For example, whether a user downloaded or did not download the specified content after receiving the network resource.

In some implementations, the computing system can train a second machine learning model on the second set of index data. In particular, the second machine learning model can be configured to output a second prediction. Even more particularly, the second prediction can describe the probability of particular user session data output in the absence of the network resource. For example, whether a user downloaded or did not download the specified content without receiving the network resource. Specifically, the incremental label can include determining a difference between the first prediction and the second prediction.

In some implementations, the computing system can train a single machine learning model. In particular, the single machine learning model can be trained on a combined set of index data (e.g., the combined set of index data can include all the data referenced above in the first set of index data and the second set of index data). Even more particularly, the single machine learning model can be configured to output a prediction that describes user session data subsequent to receipt of the network resource and in the absence of the network resource. Specifically, the single machine learning model can generate an incremental label based at least in part on a difference between the user session data subsequent to receipt of the network resource and in the absence of the network resource.

In some implementations, the computing system can determine a content value. In particular, the content value can be associated with the network resource. Even more particularly, the content value can indicate a parameter quantifying the similarity in content between a first and second network resource. For example, a content value may be favorable (e.g., high) when content in a first and second network resource is very similar. For example, if the content in the first and second network resource are both related to raising Australian Shepherd puppies. For example, the first network resource may be directed to an Australian Shepherd puppy potty training guide and the second network resource may be directed to how to feed Australian Shepherd puppies, the content value may be very high. In particular, the first set of index data and the second set of index data may be obtained in response to a first network resource (e.g., directed to potty training Australian Shepherd puppies). The computing system may determine that the content value is high enough (e.g., above a predetermined threshold) to determine an incremental label descriptive of a predicted change in user session data affected by providing the second network resource (e.g., directed to how to feed Australian Shepherd puppies). In particular, the respective incremental label for each of the third plurality of users can be based at least in part on a combination of the feature data associated with each user and the content value.

In some implementations, the computing system can generate a graphical illustration. In particular, the graphical illustration can be based at least in part on the incremental label, the first set of index data and the second set of index data. For example, the graphical illustration can illustrate visually the predicted outcome of the users' actions when provided with the network resource. As a particular example, the graphical illustration can illustrate visually the predicted outcome of the users' actions when provided with the network resource based on their rank.

In some implementations, the computing system can generate a second respective incremental label for each of the third plurality of users based on the feature data associated with the user. For example, the computing system may leverage a second set of machine learning models to generate a second predicted incremental label. The second predicted incremental label may be predicted based on the same or different training data. Furthermore, the computing system is not limited to only two respective incremental labels for each of the third plurality of users but can generate any number of respective incremental labels for each of the third plurality of users.

In some implementations, the computing system can generate a comparison score. In particular, the comparison score can indicate a parameter descriptive of the difference between the first effectiveness score (e.g., based on the first set of machine learning models) and the second effectiveness score (e.g., based on the second set of machine learning models).

In some implementations, the computing system can determine one of the first incremental label and the second incremental label. In particular, the computing system can determine one of the first incremental label and the second incremental label based at least in part on the comparison score. For example, the computing system can select one of the two incremental labels based on which incremental labels may give a larger result. With regard to the above referenced graphical illustration, the computing system can surface more than one predicted outcome of the users' actions based on the different sets of machine learning models. In particular, the computing system can rank the third plurality of users based at least in part on the determined incremental labels and provide the network resource to each of the third plurality of users based on the ranking based on the determined incremental labels.

In some implementations, the computing system can generate a combined incremental label. In particular, the combined incremental label can be based at least in part on the first incremental label and the second incremental label. For example, the combined incremental label can be an average of the generated first and second incremental labels. Alternatively, the first and second incremental labels may be weighted differently in the combined incremental label (e.g., based on a ranking of the incremental labels determined by the computing system). In particular, the computing system can rank the third plurality of users based at least in part on the combined incremental labels and provide the network resource to each of the third plurality of users based on the ranking based on the combined incremental labels.

Thus, the present disclosure provides systems and methods for facilitating data processing and system modeling of techniques used to transmit network resources over a communication network. In particular, the present disclosure provides systems and methods for a machine learning system which can execute predictive models for predicting the effectiveness of a particular network resource on a particular user based on feature data.

The systems and methods of the present disclosure provide a number of technical effects and benefits. As one example of a technical effect, aspects of the described technology can allow for more efficient allocation of computing resources by only using computing resources (e.g., bandwidth, processor usage, and memory usage, etc.) for those users who have a high incremental label as opposed to using computing resources for all users. This can decrease computational resources used by decreasing the amount of network resources transmitted that have no effect or negative effect on users, thus decreasing the amount of redundant network transmissions. For instance, example embodiments can decrease the number of computing resources used by generating an efficient index of users to which transmitting the network resource would be effective. This can further free up computing resources including display space on the users' end to be allocated for alternative computing and/or processing functions. For example, the freed display space can instead be used to surface a different network resource that is better suited to the particular user. This can result in a more efficient utilization of processing resources.

With reference now to the Figures, example embodiments of the present disclosure will be discussed in further detail.

### Example Devices and Systems

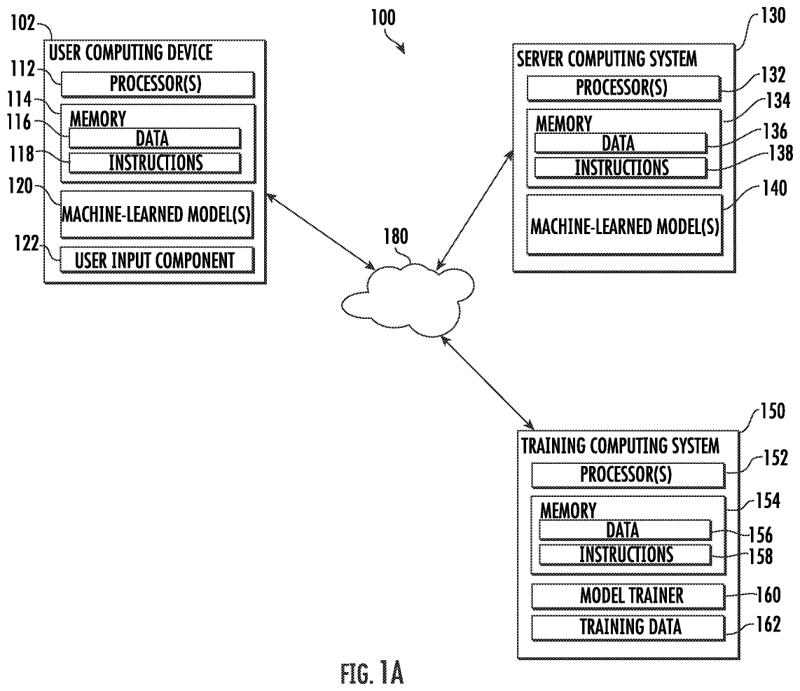

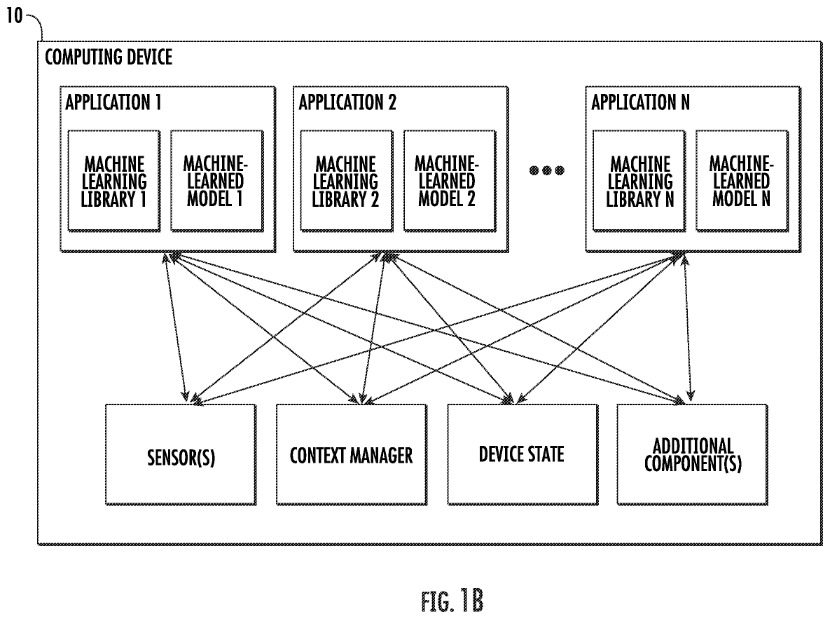

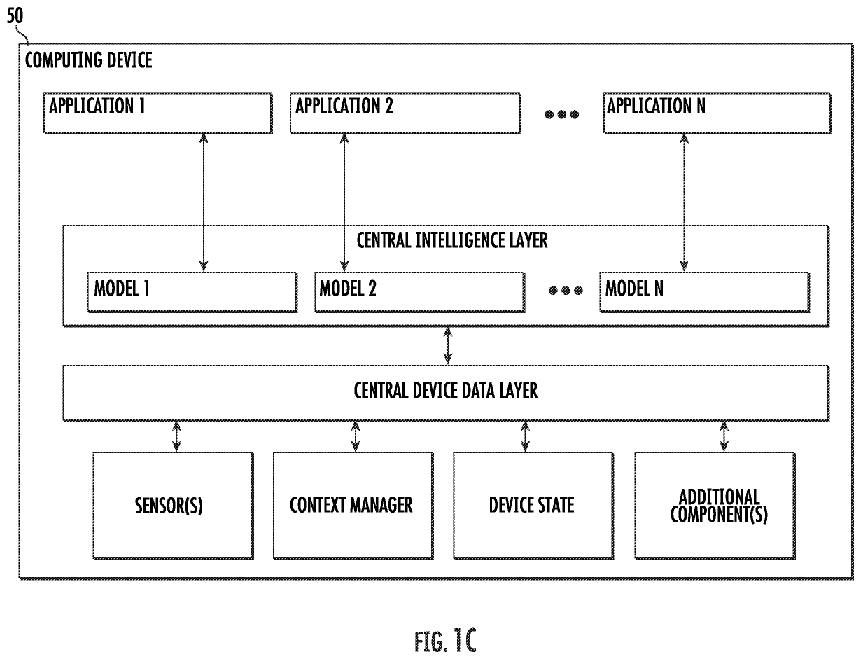

FIG. 1A depicts a block diagram of an example computing system 100 that performs predictive modeling for predicting the effectiveness of a particular network resource on a particular user based on feature data according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more network resource effectiveness prediction models 120. For example, the network resource effectiveness prediction models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example network resource effectiveness prediction models 120 are discussed with reference to FIGS. 1-6.

In some implementations, the one or more network resource effectiveness prediction models 120 can be received from the server computing system 130 over network 180, stored in the user computing device memory 114, and then used or otherwise implemented by the one or more processors 112. In some implementations, the user computing device 102 can implement multiple parallel instances of a single network resource effectiveness prediction model 120 (e.g., to perform parallel predictions of the effectiveness of a network resource across multiple instances of network resources or pluralities of users).

More particularly, the machine learning models can be directed to predictive models for predicting the effectiveness of a particular network resource on a particular user based on feature data. For example, the computing system can predict that a user may have a low likelihood of engaging in a particular action (e.g., downloading specified content, completing a transaction, interacting with a specific icon, widget, or application, launching a specific script, or some other specified action) prior to engaging with the network resource but have a high likelihood of engaging in the particular action post engaging with the network resource. The computing system can reference one or more indexes of data relating to various groups of users (e.g., a group of users which have engaged with the network resource and a group of users which have not engaged with the network resource) upon which the machine learning model can be trained.

Additionally, or alternatively, one or more network resource effectiveness prediction models 140 can be included in or otherwise stored and implemented by the server computing system 130 that communicates with the user computing device 102 according to a client-server relationship. For example, the network resource effectiveness prediction models 140 can be implemented by the server computing system 140 as a portion of a web service (e.g., a network resource effectiveness prediction service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more network resource effectiveness prediction models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-6.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be back propagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the network resource effectiveness prediction models 120 and/or 140 based on a set of training data 162. The training data 162 can include, for example, index data associated with providing the network resource to a first plurality of users as well as index data associated with not providing the network resource to a second plurality of users. For instance, the computing system can obtain indices of data indicating that “user A associated with feature 2 engaged in the particular action.” In response, the computing system can train one or more machine learning models based on the data obtained from the first and second plurality of users in order to generate predicted incremental labels for each of a respective third plurality of users.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

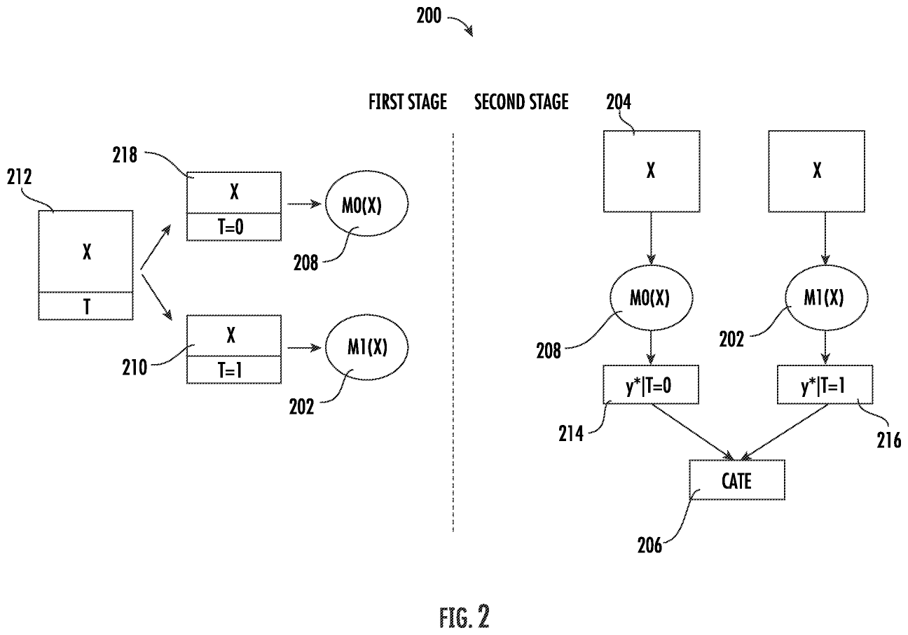

FIG. 2 depicts a block diagram of an example network resource effectiveness prediction system 200 according to example embodiments of the present disclosure. In particular, Y is used to represent outcome (e.g., 0: not engage, 1: engage), X is used to represent users' features, and T to represent treatment assignment. In some implementations, the network resource effectiveness prediction system 200 is trained to receive a set of input data 204 descriptive of a plurality of users and, as a result of receipt of the input data 204, provide output data 206 that is descriptive of an effectiveness score. Thus, in some implementations, the network resource effectiveness prediction system 200 can include a first machine learning model 202 and a second machine learning model 208 that is operable to predict user session data.

In particular, the network resource effectiveness prediction system 200 can train a first machine learning model 202 on the first set of index data 210 (e.g., μ₁(x)=E[Y|T=1, X]). Specifically, the first set of index data 210 can be directed to a first plurality of users which can be taken from a larger pool of users 212. In particular, the first machine learning model 202 can be configured to output a first prediction 216. Even more particularly, the first prediction 216 can describe the probability of particular user session data output subsequent to receipt of the network resource. For example, whether a user downloaded or did not download the specified content after receiving the network resource. As another particular example, a propensity score weighting can be used to debias the first machine learning model.

In some implementations, the computing system can train a second machine learning model 208 on the second set of index data 218 (e.g., μ₀(x)=E[Y|T=0, X]). In particular, the second machine learning model 208 can be configured to output a second prediction 214. Even more particularly, the second prediction 214 can describe the probability of particular user session data output in the absence of the network resource. For example, whether a user downloaded or did not download the specified content without receiving the network resource. Specifically, the incremental label 206 can include determining a difference between the first prediction 216 and the second prediction 214 (e.g., τ\hat{ }(x)ᵢ=M₁(Xᵢ)−M₀(Xᵢ)).

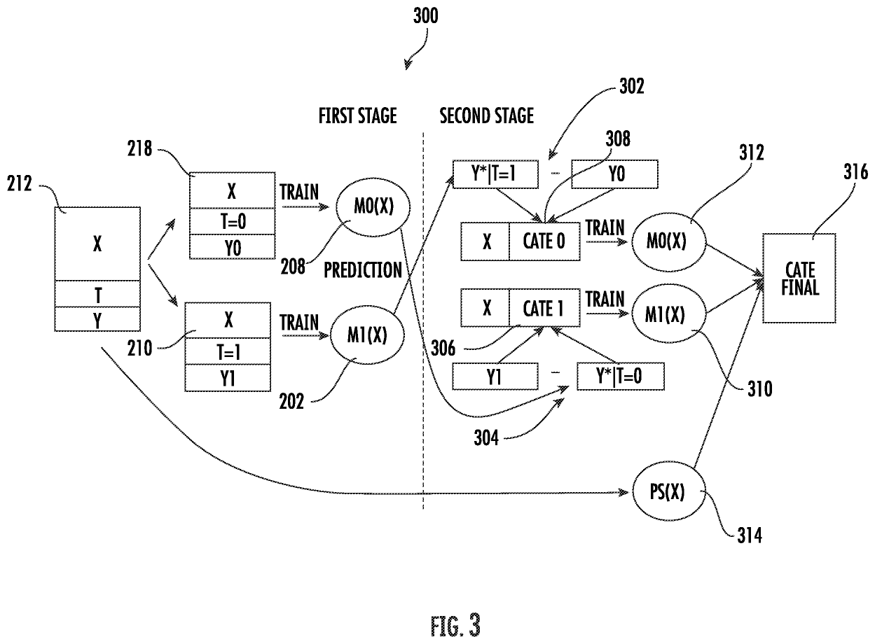

FIG. 3 depicts a block diagram of an example network resource effectiveness prediction system model 300 according to example embodiments of the present disclosure. The example network resource effectiveness prediction system model 300 is similar to the example network resource effectiveness prediction system model 200 of FIG. 2 in the first stage. However, the second stage of the example network resource effectiveness prediction system model 300 diverges. In some implementations, the computing system can modify a first output 202 of the first machine learning model 210. In particular, modifying the first output 202 can be descriptive of fitting the first output 202 of the first machine learning model 210. Even more particularly, fitting the first output 202 is descriptive of removing bias due to few data points. Furthermore, the computing system can modify a second output 208 of the second machine learning model 218. In particular, modifying the second output 208 of the second machine learning model 218 can be descriptive of fitting the second output 208 of the second machine learning model 218. Specifically, the first and second outputs 202 and 208 of the first and second machine learning models 210 and 218 can be leveraged for computation 1 304 and computation 2 302 (e.g., τ\hat{ }(X, T=0)=M\hat{ }₁(X, T=0)−Y_{T=0} and τ\hat{ }(X, T=1)=Y_{T=1}−M\hat{ }₀(X, T=1)). The computation 1 output 306 and computation 2 output 308 can be input into a third machine learning model 310 and a fourth machine learning model 312 (e.g., M\hat{ }_{τ0}(X)≈E[τ\hat{ }(X)|T=0] and M\hat{ }_{τ1}(X)≈E[τ\hat{ }(X)|T=1]).

In some implementations, the computing system can output an incremental label 316 based on the outputs of the third machine learning model 310 and the fourth machine learning model 312 and a propensity score model 314. In particular, the propensity score model 314 can input the outputs of the third machine learning model 310 and the fourth machine learning model 312. Even more particularly, a propensity score can be generated by the propensity score model 312. Furthermore, a determination of whether the third machine learning model 310 or the fourth machine learning model 312 is more accurate can be determined (e.g., based on the output of the propensity score model 312). The propensity score model 312 can predict which machine learning model is more accurate and thus the propensity score model 312 can generate a weighted output of a combination of the third machine learning model 310 and the fourth machine learning model 314 wherein the more accurate model is weighted more heavily. The computing system can output the incremental label 316 with proper weighting of the outputs of the third machine learning model 310 and the fourth machine learning model 312 based on a calculation (e.g., τ(x)\hat{ }=M\hat{ }_{τ0}(X)(e\hat{ }(x))+M\hat{ }_{τ1}(X)(1−e\hat{ }(x)) where e\hat{ }(x) represents the propensity score model).

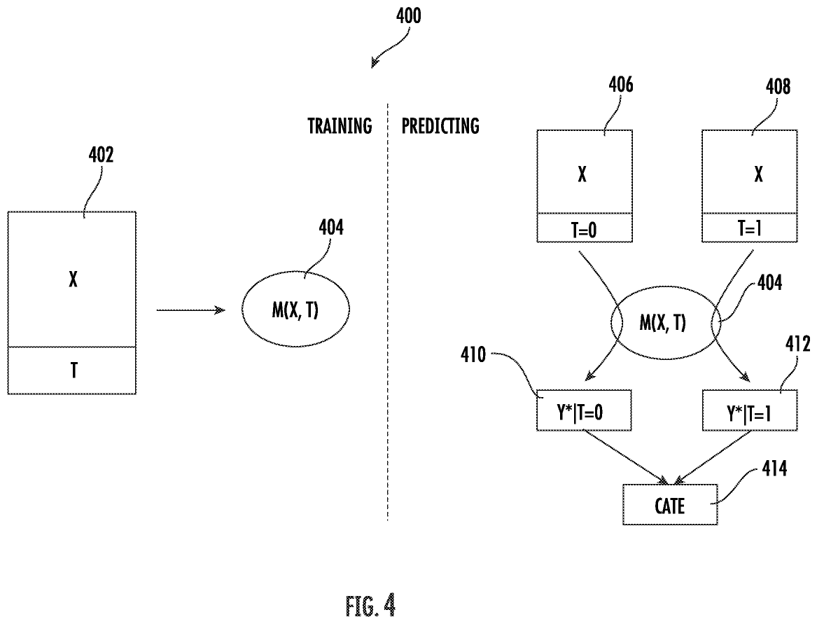

FIG. 4 depicts a block diagram of an example network resource effectiveness prediction system model 400 according to example embodiments of the present disclosure.

In particular, example network resource effectiveness prediction system model 400 uses a single machine learning model 404. In particular, the single machine learning model can be trained on a combined index data set 402. Even more particularly, the single machine learning model 404 can be configured to output a prediction that describes user session data subsequent to receipt of the network resource and in the absence of the network resource. For example, the single machine learning model 404 can input network resource index data 408 and absence of network resource index data 406 and output network resource predictions 412 and absence of network resource predictions 410. Specifically, the single machine learning model 404 can generate an incremental label 414 based at least in part on a difference between the network resource predictions 412 and absence of network resource predictions 410 (e.g., τ\hat{ }(x)ᵢ=Mₛ(Xᵢ, T=1)−Mₛ(Xᵢ, T=0). Even more particularly, a propensity score weighting may be used to debias the machine learning model.

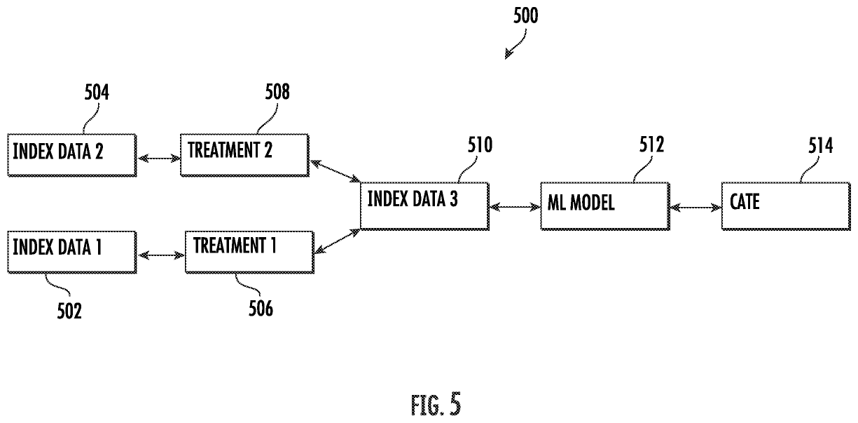

FIG. 5 depicts a block diagram of an example network resource effectiveness prediction system model 500 according to example embodiments of the present disclosure.

In some implementations, the computing system can generate a combined set of treated index data 510. In particular, the combined set of treated index data 510 can include data resulting from applying a first treatment value 506 to the first set of index data 502 and a second treatment value 508 to the second set of index data 504. For example, the first treatment value 506 can be associated with providing the network resource to those users (e.g., a positive value). Furthermore, the second treatment value 508 can be associated with the absence of the network resource to those users (e.g., a negative value).

In some implementations, the computing system can train one or more machine learning models 512 based on the combined set of treated index data 510. In particular, the one or more machine learning models 512 can be a regression machine learning model. Even more particularly, the one or more regression machine learning model 512 may output predictions indicating treatment effect on the third plurality of users (e.g., an incremental label 514) based on calculations such as E[Converted(1)ᵢ−Converted(0)ᵢ|Xᵢ=x]=τ(x)ᵢ.

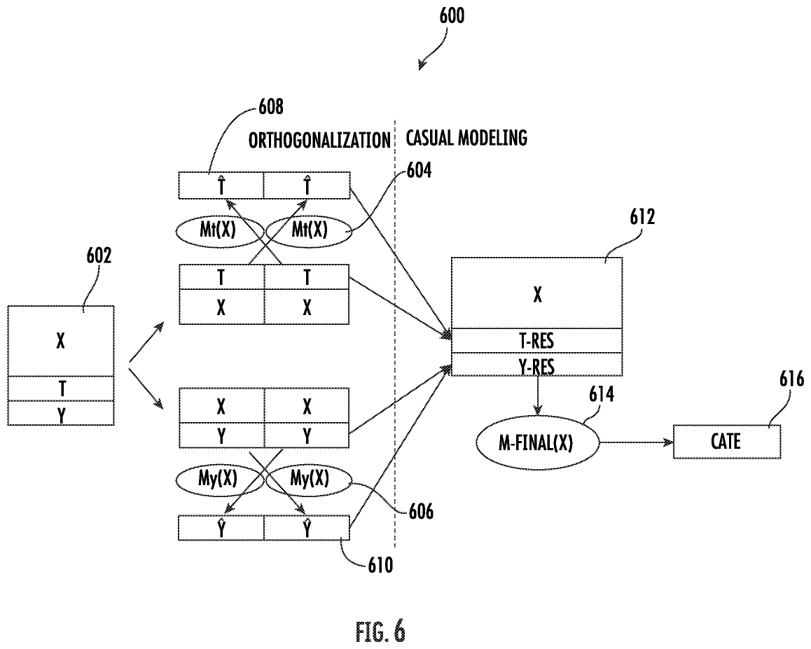

FIG. 6 depicts a block diagram of an example network resource effectiveness prediction system model 600 according to example embodiments of the present disclosure.

In some implementations, the computing system can train a first machine learning model 604 based on a combined set of data 602 wherein the combined set of data 602 can include the first set of index data and the second set of index data referenced in prior examples. In particular, the first machine learning model can be configured to output a prediction of debiasing residuals 608 that describes whether a particular user received treatment or not (e.g. t\tilde{ }=t−Mₜ(X)). Specifically, the first machine learning model 604 can include a debiasing model that can be used in order to predict debiasing residuals 608 which are orthogonal to the features used to construct it. Thus, the debiasing residuals 608 can be subtracted from the combined set of data 602 to obtain the modified combined set of data 612.

In some implementations, the computing system can train a second machine learning model 606 based on the combined set of data 602. In particular, the second machine learning model 606 can be configured to output a prediction of denoising residuals 610 that describes user session data (e.g., y\tilde{ }=y−M_{y}(X)). Specifically, the second machine learning model 606 can include a denoising model wherein the residuals that can be attributed due to variance can be predicted. Thus, the denoising residuals 610 can be subtracted from the combined set of data 602 to obtain the modified set of data 612.

In some implementations, the computing system can train a third machine learning model 614 based on the modified set of data 612. In particular, the third machine learning model 614 can be a regression model with a linear approximation to predict the incremental label. In particular, the denoising residuals 610 can be regressed on the debiasing residuals 608 to obtain the incremental label 616. Alternatively, the debiasing residuals 608 can interact with covariates (e.g., the combined set of data 602) to estimate the incremental label 616.

### Example Graphical Interface

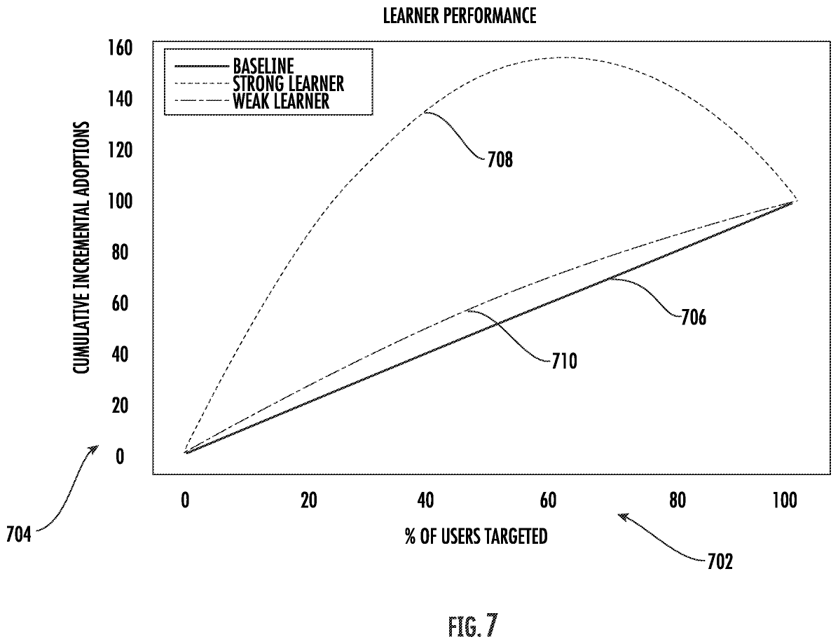

FIG. 7 depicts a visual illustration of the performance of a causal model. In particular, the computing system can rank the users based on their effectiveness score (e.g., from largest to lowest). For the top number of users, since users with similar effectiveness scores may be likely to have similar features, the randomization can be preserved. The outcome among users in the treated and control groups can be compared. In particular, when users are randomly permuted, a sequence may be able to be observed hovering around the average treatment effect which represents the baseline performance without optimization. In order to visualize the performance of a causal model, the percent of users receiving the network resources can be plotted on the x axis 702. Furthermore, the cumulative incremental adoptions can be plotted on the y axis 704. The cumulative incremental adoptions can be obtained by multiplying the incremental adoption gain by the sample size. Thus, cumulative incremental adoptions can represent the incremental sales when targeting a particular number of users. For baseline 706 performance, the curve can start from 0 and end at the total incremental adoptions. For a meta-learner's curve, it may start from 0 and end at the total incremental adoptions as well, however a strong learner 708 may be far above the baseline while a weak learner 710 may be very close to the baseline 706.

Although not shown in the Figures, in some implementations, a relative incremental adoption gain may be obtained by dividing the cumulative gain curve for a learner by the cumulative baseline 706 curve. Thus, a graph illustrating how many times of incremental adoptions are gained relative to the baseline 706 can be achieved.

### Example Methods

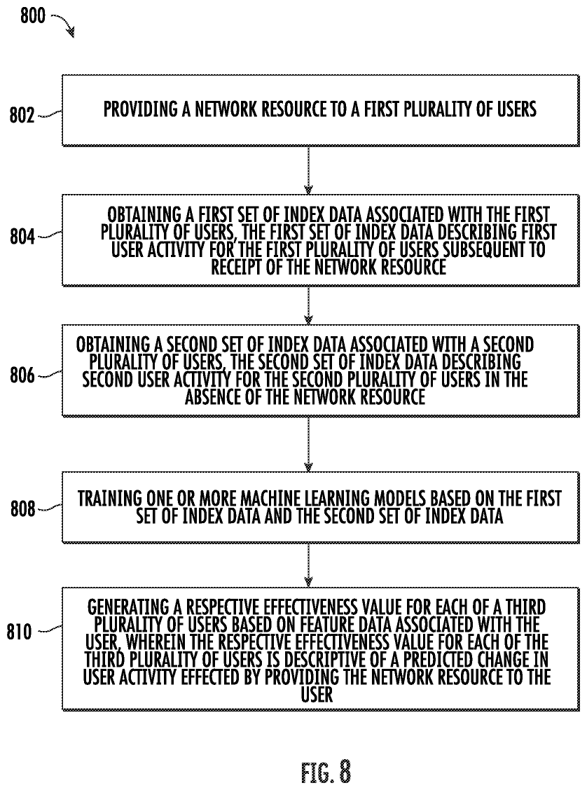

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system may provide a network resource to a first plurality of users. For example, the computing system can provide the network resource to the first plurality of users over a network (e.g., a server).

At 804, the computing system can obtain a first set of index data. In particular, the first set of index data can be associated with the first plurality of users. Even more particularly, the first set of index data can describe a set of first user session data for the first plurality of users. Specifically, the user session data can be subsequent to the receipt of the network resource. As a particular example, some number of users may engage in a particular action such as downloading specified content after receipt of the network resource. Alternatively, some number of users may not engage in the particular action such as downloading specified content after receipt of the network resource. Continuing the example, the first set of index data can indicate users who did or did not download the specified content after receiving the network resource.

At 806, the computing system can obtain a second set of index data. In particular, the second set of index data can be associated with a second plurality of users (e.g., separate from the first plurality of users). Even more particularly, the second set of index data can describe second user session data for the second plurality of users. Specifically, the second user session data can be descriptive of user session data of the second plurality of users in the absence of the network resource. As a particular example, some number of users may engage in a particular action such as downloading specified content in the absence of any network resource. Alternatively, some number of users may not engage in the particular action such as downloading specified content without any network resource. Continuing the example from above, the second set of index data can indicate users who did or did not download the specified content without receiving any network resource.

At 808, the computing system can train one or more machine learning models. In particular, the computing system can train one or more machine learning models based on the first set of index data. Furthermore, the computing system can train the one or more machine learning models based on the second set of index data in combination with associated feature data. Continuing the example from above, the computing system can train the one or more machine learning models by inputting index data describing whether individual users downloaded the specified content with and without receiving a particular network resource.

At 810, the computing system can generate a respective incremental label. In particular, the computing system can generate the respective incremental label using the one or more machine learning models. Even more particularly, the computing system can generate the respective incremental label for each of a third plurality of users (e.g., separate from the first and second plurality of users). Specifically, the computing system can generate the respective incremental label for each of the third plurality of users based on feature data associated with each user. For example, feature data can be any user demographic information (e.g., age, gender, ethnicity, geographic location, occupation, etc.). As another example, feature data can be historical user data (e.g., user browsing history, user location history, etc.). In particular, users may have the option to indicate whether they approve of sharing demographic information and/or historical user data with the computing system (e.g., by indicating on a user interface whether they approve or not).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

1. A computer-implemented method, comprising:
providing, by a computing system comprising one or more processors, a network resource to a first plurality of users;
obtaining, by the computing system, a first set of index data associated with the first plurality of users, the first set of index data describing first user session data for the first plurality of users subsequent to receipt of the network resource;
obtaining, by the computing system, a second set of index data associated with a second plurality of users, the second set of index data describing second user session data for the second plurality of users in the absence of the network resource;
training, by the computing system, one or more machine learning models based on the first set of index data and the second set of index data;
generating, by the computing system using the one or more machine learning models, a first probability and a second probability for each of a third plurality of users based on feature data associated with such user, wherein the first probability is a respective probability of user session data subsequent to receipt of the network resource and the second probability is a respective probability of the user session data in absence of the network resource;
generating, by the computing system, an incremental label for each of the third plurality of users, wherein the respective incremental label for each of the third plurality of users is descriptive of a difference in the first probability and the second probability for such user.

2. The computer-implemented method of claim 1, comprising:
ranking, by the computing system, the third plurality of users based at least in part on the incremental label;
determining, by the computing system, whether to provide the network resource to each of the third plurality of users based at least in part on the ranking; and
providing, by the computing system, the network resource to each of the third plurality of users for which a determination was made to provide the network resource.

3. The computer-implemented method of claim 1, wherein the one or more machine learning models comprise:
a first machine learning model trained on the first set of index data and configured to output a first prediction that describes a probability of user session data subsequent to receipt of the network resource;
a second machine learning model trained on the second set of index data and configured to output a second prediction that describes a probability of user session data in the absence of the network resource; and
wherein generating, by the computing system, the incremental label comprises determining a difference between the first prediction and the second prediction.

4. The computer-implemented method of claim 3, comprising:
generating a modified output of the first machine learning model, wherein the modified output comprises fitting the output of the first machine learning model, and wherein fitting the output comprises removing bias due to few data points;
generating a modified output of the second machine learning model, wherein the modified output comprises fitting the output of the second machine learning model, and wherein fitting the output comprises removing bias due to few data points;
leveraging a third machine learning model wherein the third machine learning model inputs the modified output of the first machine learning model;
leveraging a fourth machine learning model wherein the fourth machine learning model inputs the modified output of the second machine learning model;
generating a propensity score based on the outputs of the third and fourth machine learning models; and
wherein generating, by the computing system, the incremental label comprises combining the outputs of the third and fourth machine learning model based on the propensity score.

5. The computer-implemented method of claim 1, wherein the one or more machine learning models comprise:
a single machine learning model trained on a combined set of data wherein the combined set of data includes the first set of index data and the second set of index data and wherein the single machine learning model is configured to output a first probability wherein the first probability is directed to a respective probability of user session data subsequent to receipt of the network resource and a second probability wherein the second probability is directed to a respective probability of user session data in absence of the network resource for each of a third plurality of users.

6. The computer-implemented method of claim 1, comprising:
generating, by the computing system, a third set of index data wherein the third set of index data comprises applying a first treatment value to the first set of index data and a second treatment value to the second set of index data; and
training, by the computing system, the one or more machine learning models based on the third set of index data.

7. The computer-implemented method of claim 1, wherein the one or more machine learning models comprise:
a first machine learning model trained on a combined set of data wherein the combined set of data comprises the first set of index data and the second set of index data and wherein the first machine learning model is configured to output a prediction that describes whether a particular user received treatment or not;
a second machine learning model trained on the combined set of data and configured to output a prediction that describes user session data;
a modified set of data wherein the modified set of data comprises subtracting the output of the first machine learning model and the output of the second machine learning model from the combined set of data; and
a third machine learning model trained on the modified set of data configured to output the incremental label.

8. The computer-implemented method of claim 1, comprising:
determining, by the computing system, a content value associated with the network resource, wherein the content value is a parameter quantifying a similarity in content between first and second network resources;
wherein the first set of index data and the second set of index data is obtained in response to the first network resource;
wherein the respective incremental label for each of the third plurality of users is descriptive of a predicted change in user session data effected by providing the second network resource to the user; and
wherein generating the respective incremental label for each of the third plurality of users is based at least in part on a combination of feature data associated with the user and the content value.

9. The computer-implemented method of claim 1, comprising:
generating, by the computing system, a graphical illustration based at least in part on the incremental label, the first set of index data, and the second set of index data; and
surfacing, by the computing system, the graphical illustration to a user.

10. The computer-implemented method of claim 1, wherein the incremental label is a first incremental label, the method, comprising:
generating, by the computing system using the one or more machine learning models, a second respective incremental label for each of the third plurality of users based on the feature data associated with the user.

11. The computer-implemented method of claim 10, comprising:
generating, by the computing system, a comparison score wherein the comparison score is a parameter descriptive of the difference between the first incremental label and the second incremental label.

12. The computer-implemented method of claim 11 further comprising:
determining, by the computing system, one of the first incremental label and the second incremental label based at least in part on the comparison score;
ranking, by the computing system, the third plurality of users based at least in part on the determined incremental label; and
providing, by the computing system, the network resource to each of the third plurality of users based on the ranking.

13. The computer-implemented method of claim 11 further comprising:
generating, by the computing system, a combined incremental label based at least in part on the first incremental label and the second incremental label;
ranking, by the computing system, the third plurality of users based at least in part on the combined incremental label; and
providing, by the computing system, the network resource to each of the third plurality of users based on the ranking.

14. The computer-implemented method of claim 13, wherein the first incremental label and the second incremental label are weighted differently in the combined incremental label.

15. A computing system, comprising:
one or more processors; and
one or more non-transitory, computer-readable media that store instructions that when executed by the one or more processors cause the computing system to perform operations, the operations comprising:
obtaining, by the computing system, a first set of index data associated with a first plurality of users, the first set of index data describing first user session data for the first plurality of users subsequent to receipt of a network resource;
obtaining, by the computing system, a second set of index data associated with a second plurality of users, the second set of index data describing second user session data for the second plurality of users in the absence of the network resource;
training, by the computing system, one or more machine learning models based on the first set of index data and the second set of index data;
generating, by the computing system using the one or more machine learning models, a first probability and a second probability for each of a third plurality of users based on feature data associated with such user, wherein the first probability is a respective probability of user session data subsequent to receipt of the network resource and the second probability is a respective probability of the user session data in absence of the network resource;
generating, by the computing system, an incremental label for each of the third plurality of users, wherein the respective incremental label for each of the third plurality of users is descriptive of a difference in the first probability and the second probability for such user.

16. The computing system of claim 15, wherein the operations comprise:
ranking the third plurality of users based at least in part on the incremental label;
determining whether to provide the network resource to each of the third plurality of users based at least in part on the ranking; and
providing the network resource to each of the third plurality of users for which a determination was made to provide the network resource.

17. One or more computer-readable media that store instructions that, when executed by one or more processors of a computing system, cause the computing system to perform operations comprising:
obtaining feature data associated with a candidate user; and
determining whether to provide a network resource to the candidate user based on the feature data associated with a candidate user, wherein said determining comprises:
accessing one or more machine learning models that have been trained using a first set of index data and a second set of index data,
wherein the first set of index data is associated with a first plurality of users and describes first user session data for the first plurality of users subsequent to receipt of a network resource;
wherein the second set of index data is associated with a second plurality of users and describes second user session data for the second plurality of users in the absence of the network resource;
generating using the one or more machine learning models, a first probability and a second probability for each of a third plurality of users based on feature data associated with such user, wherein the first probability is a respective probability of user session data subsequent to receipt of the network resource and the second probability is a respective probability of the user session data in absence of the network resource; and
generating an incremental label for each of the third plurality of users, wherein the respective incremental label for each of the third plurality of users is descriptive of a difference in the first probability and the second probability for such user.

18. The one or more computer-readable media of claim 17, the operations comprising:
ranking the third plurality of users based at least in part on the incremental label;
determining whether to provide the network resource to each of the third plurality of users based at least in part on the ranking; and
providing the network resource to each of the third plurality of users for which a determination was made to provide the network resource

19. The one or more computer-readable media of claim 17, wherein the one or more machine learning models comprise:
a first machine learning model trained on the first set of index data and configured to output a first prediction that describes user session data subsequent to receipt of the network resource;
a second machine learning model trained on the second set of index data and configured to output a second prediction that describes user session data in the absence of the network resource; and
wherein generating the incremental label comprises determining a difference between the first prediction and the second prediction.

20. The one or more computer-readable media of claim 19, the operations comprising:
generating a modified output of the first machine learning model, wherein the modified output comprises fitting the output of the first machine learning model, and wherein fitting the output comprises removing bias due to few data points;
generating a modified output of the second machine learning model, wherein the modified output comprises fitting the output of the second machine learning model, and wherein fitting the output comprises removing bias due to few data points;
generating a propensity score based on the modified outputs of the first machine learning model and the second machine learning model; and
modifying the incremental label based on the propensity score.
